(19) United States
(12) Patent Application Publication
(10) Pub. No.: US 2014/0046789 A1
(43) Pub. Date: Feb. 13, 2014

(54) Fast Transactions

(71) Applicant: Pradeep Bantwal Baliga, TamilNadu (IN)

(72) Inventor: Pradeep Bantwal Baliga, TamilNadu (IN)

(73) Assignee: eBay, Inc., San Jose, CA (US)

(21) Appl. No.: 13/570,990

(22) Filed: Aug. 9, 2012

(51) Int. Cl. G06Q 30/00

(52) U.S. Cl. 705/26.1

(57) ABSTRACT

Systems and methods according to one or more embodiments provide an option for conducting fast transactions in connection with one or more desired items. In one embodiment, a system comprises one or more processors; and one or more memories adapted to store a plurality of machine-readable instructions which when executed by the processor(s) cause the system to: receive information from a user about an intent to conduct a transaction; determine a current location of the user; determine one or more seller locations near the current location of the user; and provide time delay information to the user for the one or more seller locations.

### BACKGROUND

1. Technical Field

Embodiments of the present disclosure generally relate to transactions, and more particularly, to methods and systems for conducting transactions in a fast manner.

2. Related Art

Customers regularly engage in transactions at one or more sellers' locations, for example, to purchase one or more products or services at the sellers' locations. In some cases, the customers may generally search online for the nearest seller locations that offer a desired product or service. Once the customer selects a seller's location, the customer may go to the selected location and walk around to peruse different products or services offered by the seller before potentially purchasing the product or service. However, the customer may sometimes find that the selected seller location is crowded and may be delayed when completing a purchase because he or she may have to wait in long lines at, for example, a cash register, especially during busy times.

### BRIEF DESCRIPTION OF THE FIGURES

FIG. 1 is a block diagram illustrating a system adapted to provide an option for conducting fast transactions according to an embodiment of the present disclosure.

FIG. 2 is a diagram illustrating a method for providing a fast way of conducting transactions according to an embodiment of the present disclosure.

FIG. 3 is a diagram illustrating a method for fast transaction options using a user device according to an embodiment of the present disclosure.

FIG. 4 illustrates a block diagram of a system for implementing a device according to one embodiment of the present disclosure.

Like element numbers in different figures represent the same or similar elements.

### DETAILED DESCRIPTION

In accordance with various embodiments described herein, methods and systems are provided for conducting transactions in a fast manner.

Currently, when a customer desires to conduct a transaction associated with an application, product or service (“item”), the customer may search for a business location, e.g., a retail store or food establishment that may offer the item. As an example, the customer may search for a nearest business location that offers a desired item using any appropriate search tool such as an application or a search engine site, for example, www.where.com (a service by PayPal® of San Jose, Calif., USA). Although the search may provide the customer with the nearest business locations offering the desired item, it may not necessarily be the fastest way to conduct a transaction. It may be difficult to guess how crowded the business locations are. For example, when the customer finds the nearest business locations, such locations may be busy or crowded so that conducting a transaction associated with the desired item may be slow or delayed due to, for example, having to wait in long lines.

According to one or more embodiments or the present disclosure, customers may be provided with an option for a fast way of conducting transactions in connection with a desired item (e.g., viewing, monitoring, bidding, shopping, purchasing, etc.). For example, fastest transaction options may be provided indicating business locations that may have decreased time delays, e.g., business locations where the time that a customer stands in line waiting (wait time) for an available Point of Sale (POS) device such as a checkout or cash register, is decreased.

In an embodiment, an application may be provided from a service provider or an entity to customers (also referred to as “users” or “clients”) such that the customers may choose to load or install and run the application on their user devices. The application may enable customers to get information to determine where or how to conduct a fast transaction. In that regard, the customer may have an option to search for business locations by the fastest transaction option. For example, the customer may get different wait times associated with different POS devices at one or more business locations so that the customer may opt to, for example, shop at a business location that is less crowded and/or check out at a POS device having the least delay or wait time.

In one or more embodiments, customers may enter or upload information (e.g., information regarding the wait times at particular POS devices at one or more business locations) to a tracking database. The tracking database may record the information so that time delays at different business locations and/or between POS devices may be determined and published for use in determining the fastest ways to conduct transactions. The application may be provided by a service provider such as PayPal® and/or eBay® of San Jose, Calif.

Advantageously, searching for business locations based on a fastest transaction option may lead to finding less crowded business locations, which may result in, for example, less wait time, more parking spaces for vehicles, etc. In one or more embodiments, a combination of the fastest transaction and a nearest location may save a lot of time for customers.

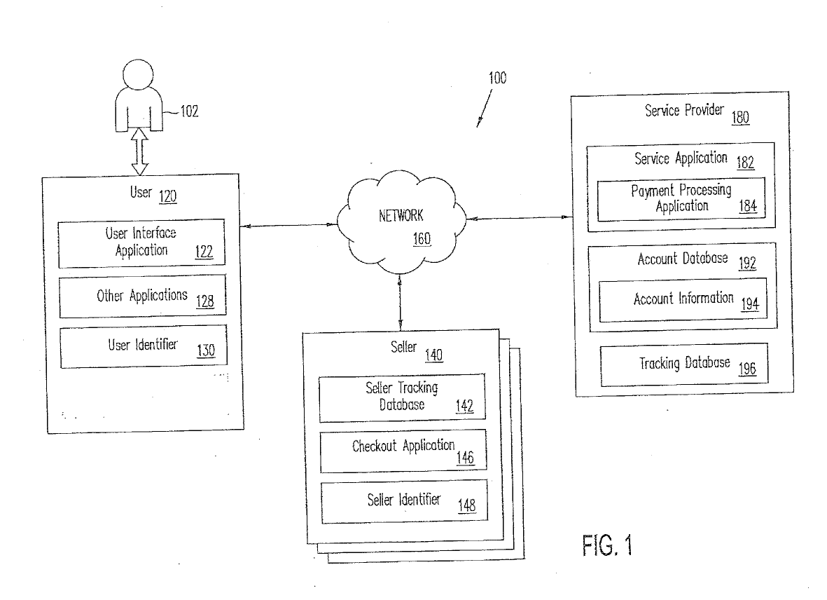

Referring now to the drawings wherein the showings are for purposes of illustrating embodiments of the present disclosure only, and not for purposes of limiting the same, FIG. 1 is a block diagram illustrating a system for providing a fast way of conducting transactions according to an embodiment of the present disclosure.

FIG. 1 illustrates an embodiment of a block diagram of a system 100 adapted to provide an option for conducting fast transactions according to an embodiment of the present disclosure. System 100 includes at least one user device 120 (e.g., network computing device) associated with a user 102, one or more entity or seller servers or devices 140 (e.g., network server devices), and at least one service provider server or device 180 (e.g., network server device) in communication over a network 160.

The network 160, in one embodiment, may be implemented as a single network or a combination of multiple networks. For example, in various embodiments, the network 160 may include the Internet and/or one or more intranets, cloud, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, the user device 120, seller servers or devices 140, and service provider server or device 180 may be associated with a particular link (e.g., a link such as a URL (Uniform Resource Locator) to an IP (Internet Protocol) address).

The user device 120, in various embodiments, may be implemented using any appropriate combination of hardware and/or software configured for wired and/or wireless communication over the network 160. In various examples, the user device 120 may be implemented as a wireless telephone (e.g., cellular, mobile, etc.), a smart phone, a tablet, a personal digital assistant (PDA), a personal computer, a notebook computer, and/or various other generally known types of wired and/or wireless computing devices. It should be appreciated that the user device 120 may also be referred to as a client device or a customer device without departing from the scope of the present disclosure.

The user device 120, in one embodiment, includes a user interface application 122, which may be utilized by the user 102 to conduct transactions such as financial transactions (e.g., shopping, purchasing, bidding, etc.) with the service provider server 180 over the network 160. In one aspect, purchase expenses may be directly and/or automatically debited from an account related to the user 102 via the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160. In another example, the user 102 is able to access websites for searching entity locations offering desired items, for example, search engine websites including, www.where.com, a PayPal® service, which may find the nearest business locations for a desired item. In yet another example, the user 102 is able to access seller websites or lists of inventories via the one or more seller servers or devices 140 to view and select items and/or services for purchase, and the user 102 is able to purchase items and/or services from the one or more seller servers or devices 140 via the service provider server 180. Accordingly, the user 102 may conduct transactions such as financial transactions (e.g., view, purchase and pay for items and/or services) from the one or more seller servers or devices 140 via the service provider server 180.

The user device 120, in various embodiments, may include other applications 128 as may be desired in one or more embodiments of the present disclosure to provide additional features available to the user 102. In one example, such other applications 128 may include security applications for implementing client-side security features, programmatic client applications for interfacing with appropriate application programming interfaces (APIs) over the network 160, and/or various other types of generally known programs and/or software applications. In still other examples, the other applications 128 may interface with the user interface application 122 for improved efficiency and convenience.

According to one or more embodiments, the user interface application 122 or the other applications 128 include a fast transaction application that may be loaded on user device 120 from service provider server 180, from a seller server 140 or from any other suitable server. Such application provides user device 120 with a fast transaction option, for example, it may enable user device 120 to determine how crowded nearby seller locations may be, thus indicating how fast a transaction may be conducted at particular locations and providing an option to choose a less crowded location for a fast transaction. In addition, the application may enable uploading of time delay information to a database, for example, the time it takes customers to make payments at one or more POS devices in one or more business locations. In various embodiments, the time delay information may be uploaded to a tracking database 196 of service provider server 180 or to a seller tracking database 142 of seller server 140.

In an embodiment, user device 120 may include at least one user identifier 130, which may be implemented, for example, as operating system registry entries, cookies associated with the user interface application 122, identifiers associated with hardware of the user device 120, or various other appropriate identifiers. The user identifier 130 may include one or more attributes related to user 102, such as personal information related to user 102 (e.g., one or more user names, passwords, photograph images, biometric IDs, addresses, phone numbers, etc.) and banking information and/or funding sources (e.g., one or more banking institutions, credit card issuers, user account numbers, security data and information, etc.). In various implementations, user identifier 130 may be passed with a user login request to the service provider server 180 via the network 160, and the user identifier 130 may be used by the service provider server 180 to associate the user 102 with a particular user account maintained by the service provider server 180.

The one or more seller servers or devices 140, in various embodiments, may be maintained by one or more individuals or entities such as business entities (or in some cases, by a partner of a business entity that processes transactions on behalf of business entities). It should be appreciated that individuals or entities may also be referred to as “sellers” or “merchants” without departing from the scope of the present disclosure. Examples of sellers may include any entity such as business entities, profit or non profit, including merchant sites or locations such as retail stores, food establishments, service providers, banks, hair salons, drive-in businesses, etc., resource information sites or locations, utility sites or locations, real estate management sites or locations, etc., which may offer various items for purchase and payment.

As such, each of the one or more seller servers 140 may include a seller tracking database 142 for receiving, tracking and/or identifying time delays associated with one or more POS devices. It should be appreciated that although a user-seller transaction is illustrated in this embodiment, the system may also be applicable to user-user, seller-seller and/or seller-user transactions.

Each of the seller servers or devices 140, in one embodiment, may include a checkout application 146, which may be configured to facilitate financial transactions (e.g., purchase transactions) by the user 102 of items and/or services offered by the seller. As such, in one aspect, the checkout application 146 may be configured to accept payment information from the user 102 over the network 160.

Each of the seller servers or devices 140, in one embodiment, may include at least one seller identifier 148, which may be included as part of the one or more items and/or services made available for purchase so that, e.g., particular items and/or services are associated with particular sellers. In one implementation, the seller identifier 148 may include one or more attributes and/or parameters related to the seller, such as business and banking information. User 102 may conduct transactions such as financial transactions (e.g., selection, monitoring, purchasing, and/or providing payment for items) with each seller server 140 via the service provider server 180 over the network 160.

The service provider server 180, in one embodiment, may be maintained by a transaction processing entity, which may provide processing for financial transactions and/or information transactions between the user 102 and one or more of the seller servers 140. As such, the service provider server 180 includes a service application 182, which may be adapted to interact with each user device 120 and/or each seller server 140 over the network 160 to facilitate the tracking and identification of the user 102 as well as the selection, purchase, and/or payment of items and/or services by the user 102 from one or more of the seller servers 140. In one example, the service provider server 180 may be provided by PayPal®, Inc. and/or eBay®, Inc. of San Jose, Calif., USA.

The service application 182, in one embodiment, utilizes a payment processing module 184 to process purchases and/or payments for financial transactions between the user 102 and each of the seller servers 140. In one implementation, the payment processing module 184 assists with resolving financial transactions through validation, delivery, and settlement. As such, the service application 182 in conjunction with the payment processing module 184 settles indebtedness between the user 102 and each of the seller servers 140, wherein accounts may be directly and/or automatically debited and/or credited of monetary funds in a manner as accepted by the banking industry.

The service provider server 180, in one embodiment, may be configured to maintain one or more user accounts and seller accounts in an account database 192, each of which may include account information 194 associated with one or more individual users (e.g., user 102) and sellers (e.g., one or more sellers associated with seller servers 140). For example, account information 194 may include private financial information of each user 102 and each seller associated with the one or more seller servers 140, such as one or more account numbers, passwords, credit card information, banking information, or other types of financial information, which may be used to facilitate financial transactions between the user 102 and the one or more sellers associated with the seller servers 140. In various aspects, the methods and systems described herein may be modified to accommodate users and/or sellers that may or may not be associated with at least one existing user account and/or seller account, respectively.

In various embodiments, information about seller accounts may include historical and real-time delays or wait times for different seller locations or even different POS devices within a seller location. Historical data may include time delays or wait times based on time of year, time of day, day of week, sales periods, and the like. Real-time delays may include current wait times, such as reported by the seller or users at a seller location.

In one implementation, the user 102 may have identity attributes stored with the service provider server 180, and the user 102 may have credentials to authenticate or verify identity with the service provider server 180. User attributes may include personal information, banking information and/or funding sources as previously described. In various aspects, the user attributes may be passed to the service provider server 180 as part of a login, selection, purchase, and/or payment request, and the user attributes may be utilized by the service provider server 180 to associate the user 102 with one or more particular user accounts maintained by the service provider server 180.

The system described above with respect to the embodiment of FIG. 1 may be used to provide information for conducting fast transactions, for example, it may track time delay information in connection with one or more POS devices at one or more entity locations to indicate, for example, that a nearby location is less crowded, thus saving a lot of time for customers.

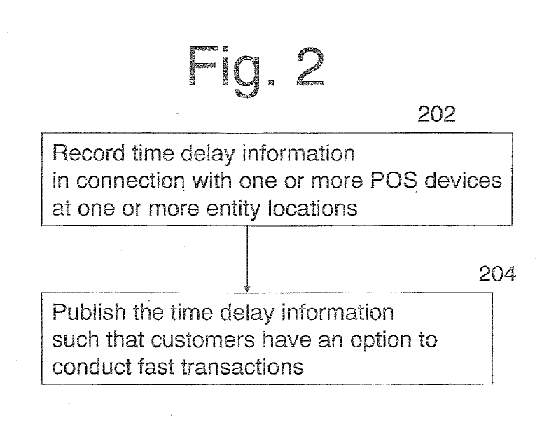

Referring to FIG. 2, a diagram illustrates a method for providing a fast way of conducting transactions according to an embodiment of the present disclosure. It should be noted that the method illustrated in FIG. 2 may be implemented by the system illustrated in FIG. 1 according to one or more embodiments.

In block 202, time delay information may be recorded in connection with one or more POS devices at one or more entity locations. The time delay information may be stored or recorded in a database at a server at a remote location, for example, in tracking database 196 of service provider server 180 or in seller tracking database 142 of seller server 140 (illustrated in FIG. 1).

In various embodiments, one or more POS devices may be located at any location, for example, in or throughout a business location, or in one or more different business locations. For instance, POS devices (e.g., checkout stands, cash registers, terminals, or the like) may be placed at or near business location exits that provide checkout services to customers in order to conduct transactions associated with one or more items offered at the business location.

Time delay information may be tracked with respect to each POS device and may be associated with an identifier, for example with a merchant identifier, a POS identifier or any other appropriate identifier. For instance, time delay information may be tracked by location, for example, by store identifier, and may be recorded in a database maintained at a remote location.

In an embodiment, each POS device may include a timer machine as part of the POS device that determines and records time delay information. Time delay information may be recorded to the remote location database, for example, when customers pay at a POS device (e.g., pay bills at a terminal). According to an embodiment, a counter may be increased each time a customer pays at a POS device. Time delay information may include counter information (e.g., counter is increased each time a customer uses a POS device). Time delay information may also include the time that it takes a particular POS device to complete a transaction. The time delay information of a POS device may then be tracked and compared to time delay information of other POS devices, for example, the time that it takes the other POS devices or checkouts to complete a transaction. Generally, it may take one particular POS device a longer time to complete a transaction than other POS devices. Factors affecting the longer time for completing a transaction may include, for example, a fast or slow checker or clerk, technical or mechanical difficulties associated with a particular POS device, time of day, dates, etc. These factors may also be recorded or stored in the database and correlated with the time delay information. As an example, during a holiday, the number of customers (captured by the counter information) in a business location may increase as well as the time for transactions to be completed (e.g. as a result of customers shopping for many items as opposed to just one or two items).

Based on the time delay information recorded on the database, the amount of time for conducting a transaction may be predicted. For example, it may be predicted how crowded or busy a business location may be. In this regard, there may be different ways to predict how crowded or busy a business location may be, including, for example:

I) Determining the number of transactions at a particular POS device within a certain amount of time may indicate how crowded or busy the business location may be. The number of transactions in a particular business location within a certain amount of time may be obtained from counter information (counting the number of customers that conduct transactions via a POS device) stored in the database. For example, the number of transactions that occurred in the last hour at a particular POS device may be determined based on the counter information. In a particular example, stored counter information may indicate that 2 customers conducted a transaction within the last hour at a first sports goods store; this may be compared to counter information indicating that 10 customers conducted a transaction within the last hour at a second sports goods store. Based on this time delay information (which includes the counter information) it may be predicted that the first sports goods store is less crowded or less busy than the second sports goods store indicating that a faster transaction may be carried out at the first sports goods store.

II. Determining the general average time gap between one or more transactions versus the average time gap between transactions within a certain amount of time may also indicate how crowded or busy the business location may be. For example, the general average time gap between two transactions may be calculated, e.g. the general average time gap may be 10 minutes between transactions for a particular business location. Then, the average time gap between transactions within the last hour may be calculated and compared to the general average time gap of 10 minutes. That is, if, for example, the average time gap between transactions in the last hour is less than 10 minutes, this may indicate that the store may be crowded or busy.

III. Determining the average wait time from when a customer reaches a POS or checkout area to the time the customer begins (or ends) the checkout process. This may be determined by determining actual wait times for individual transactions and averaging the wait times based on a number of transactions during a period (such as a time period of a specific day). Wait time information may be obtained in various ways, such as having store sensors determine when a customer reaches the POS terminal and when the customer begins or ends the checkout process. Wait time information may also be obtained by customers providing such information to a service provider, such as through their user device. For example, when a customer gets to the POS area, the customer may open a corresponding application on the user device and indicate a start time and an end time, such as by tapping or selecting a suitable input or button. The customer may also simply report a wait time after the checkout is completed. For example, after checking out at store A, the customer may report a 10 minute wait time from start of line to start of checkout and/or to end of checkout. This may provide the service provider information about both the length of wait (which may be attributed to, for example, the length of a line and/or the speed of a clerk) and the speed of the clerk. The customer may also report qualitative information, such as the lines are long, the store is getting busier, the store just added more cashiers, etc.

In other embodiments, the speed for conducting a transaction may also be calculated based on the distance to business locations and/or time delay and may take into account the price of an item. For example, as described above, time delay may be calculated based on counter information or POS time gap logic. Distance to nearby business locations may be calculated by any geographical methods or services such as GPS services, and prices of items may be found based on known search mechanisms that may find, for example, the lowest available prices for an item.

In one example where a user may be searching for a particular item and/or stores offering the particular item, the application may determine that a first store, which is about 3 miles away from a current location, has a POS transaction time delay of about 5 minutes. And a second store, which is about 4 miles away from the current location, has a POS transaction time delay of about 3 minutes. Assuming that the price for the particular item is the same at both the first and second stores, it is calculated that to reach the first store, it may take about 5 minutes, and the POS transaction time delay (shopping delay) is about 5 minutes, which may result in a total transaction time of about 10 minutes. To reach the second store, it may take about 6 minutes and the POS transaction time delay is about 3 minutes, which may result in a total transaction time of about 9 minutes. As such, the second store may be determined to be the speediest option for a fast transaction. In various embodiments, calculated times to reach a certain business location may vary depending on time of day, for example. So, the time difference between two business locations may be different for different times of the day, different days of the week, and/or different days of the year. According to one or more embodiments, the entity locations such as stores, may be ranked, for example, from fast to slow, based on the time delay, distance and potentially price, which may be for the current time or for a time in the future the customer specified, such as in two hours or at 4 p.m., where the current time may be 1 p.m.

In block 204 of FIG. 2, the time delay information in connection with one or more POS devices at one or more entity locations may be published. For example, the time delays may be published (e.g., by the server at the remote location) and may be viewed on one or more user devices having a downloaded fast transaction application as described above according to one or more embodiments. In an embodiment, the entity locations may be ranked and viewed, for example, from fast to slow. Based on the published time delays, a customer may determine the speed of transactions at particular POS devices or entity locations and have an option for conducting fast transactions. For example, the customer may determine which POS devices or entity locations are the least delayed and opt to shop at the least crowded entity locations and/or check out via the POS devices having the least delay.

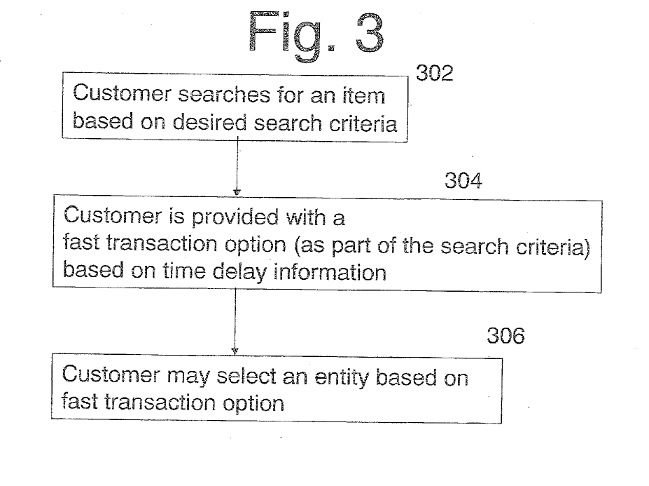

Referring now to FIG. 3, a diagram illustrates a method for fast transaction options using a user device according to an embodiment of the present disclosure.

As described above with respect to an embodiment as illustrated for example in FIG. 1, a fast transaction application may be provided to users, which users may choose to install and run on their user devices. The application may be provided for downloading from a seller or a service provider, for example, a seller associated with seller server 140 or a service provider associated with service provider server 180 illustrated in FIG. 1 according to an embodiment. In one embodiment, when user 102 (referring to FIG. 1) has a pre-existing account with service provider server 180 wherein user 102 has identity attributes stored with service provider server 180 as described above, user 102 may download the application on user device 120 from service provider server 180.

In block 302, a customer may search for one or more items based on desired search criteria that may be offered at one or more entity locations. For example, a customer may search online via a user device using a search engine site to search for particular items at nearby sporting goods stores meeting certain search criteria such as a tennis racket of a certain brand, golf shirts of a certain size and/or color, or any other desired sporting goods or items. In various embodiments the customer may also provide a desired time for shopping or arrival at a business location, which may give the service provider more relevant information to provide to the customer for a more accurate time delay or fastest transaction information. For example, the customer may not be planning to leave the customer location for a few hours, so current traffic and/or wait time data for a certain seller may be very different a few hours later.

In block 304, as part of the search criteria, the customer may be provided with a fast transaction option based on time delay information. For example, the customer may search by where the fastest transaction may be conducted. If, for example, the customer selects to search for sporting goods stores based on the fast transaction option, a database having time delay information stored at a server at a remote location may be queried to obtain the number of transactions (i.e., counter information) for one or more sporting goods stores. The search results may then be displayed on the user device, for example, the stores with the lowest to the highest value of number of transactions, i.e., the stores having the lowest number of transactions (indicating less crowded) to the stores having the highest number of transactions (indicating more crowded).

In block 306, the customer may select to conduct a transaction at an entity based on the fast transaction option. For example, when the results are displayed on the user device showing the entities indicated to have the fastest transactions (e.g. less crowded), the customer may select to shop at one of those stores. The customer may also be able to see or be notified of specific checkout lanes that are faster or slower within a specific store. This way, the customer may go directly to a certain checkout lane, which may have a faster clerk, a dedicated bagger, etc.

Advantageously, the customer may search for an entity by the fastest transaction option. That is, the fast transaction application provides the user device with a fast transaction option, for example, it may enable the user device to determine how crowded seller locations may be, thus indicating how fast a transaction may be conducted at particular locations or POS devices and providing an option to choose a less crowded location for a fast transaction. Conducting transactions (e.g., shopping) at locations that may be less crowded may result in less wait time, more parking space for a vehicle, etc. Also, as described above according to one or more embodiments, a determination for the fastest transaction may also be based on the distance of the different entity locations offering the desired item, and possibly the lowest available price. In one or more embodiments, the nearest entity in combination with the least time delays may save a lot of time for customers.

In various embodiments, the application may enable uploading of time delay information to the database, for example, the number of customers in line at a POS device, the time it takes customers to make payments at one or more POS devices in one or more business locations, etc.

According to one or more embodiments, time delay information may be detected in a manner that is not intrusive to the business entity, e.g., a merchant, such that the merchant may not need to actively report wait times in line. In an example, customers may enter or upload data including the wait time when they are at the business location.

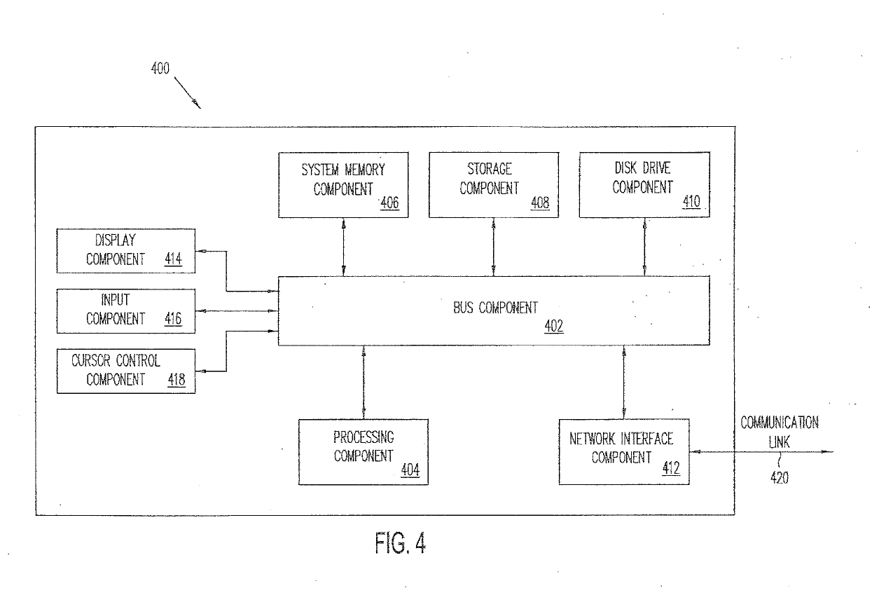

FIG. 4 is a block diagram of a system 400 suitable for implementing embodiments of the present disclosure, including user device 120, one or more seller servers or devices 140, and service provider server or device 180. System 400, such as part of a cell phone, mobile phone, smart phone, tablet, personal computer and/or a network server, includes a bus 402 or other communication mechanism for communicating information, which interconnects subsystems and components, including one or more of a processing component 404 (e.g., processor, micro-controller, digital signal processor (DSP), etc.), a system memory component 406 (e.g., RAM), a static storage component 408 (e.g., ROM), a network interface component 412, a display component 414 (or alternatively, an interface to an external display), an input component 416 (e.g., keypad, touchpad, or keyboard), and a cursor control component 418 (e.g., a mouse pad).

In accordance with embodiments of the present disclosure, system 400 performs specific operations by processor 404 executing one or more sequences of one or more instructions contained in system memory component 406. Such instructions may be read into system memory component 406 from another computer readable medium, such as static storage component 408. These may include instructions to process financial transactions, make payments, etc. In other embodiments, hard-wired circuitry may be used in place of or in combination with software instructions for implementation of one or more embodiments of the disclosure.

Logic may be encoded in a non-transitory computer readable medium, which may refer to any medium that participates in providing instructions to processor 404 for execution. Such a medium may take many forms, including but not limited to, non-volatile media, volatile media, and transmission media. In various implementations, volatile media includes dynamic memory, such as system memory component 406, and transmission media includes coaxial cables, copper wire, and fiber optics, including wires that comprise bus 402. Memory may be used to store visual representations of the different options for payments or transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 400. In various other embodiments, a plurality of systems 400 coupled by communication link 420 (e.g., network 160 of FIG. 1, LAN, WLAN, PTSN, or various other wired or wireless networks) may perform instruction sequences to practice the disclosure in coordination with one another. System 400 may transmit and receive messages, data, information and instructions, including one or more programs (i.e., application code) through communication link 420 and communication interface 412. Received program code may be executed by processor 404 as received and/or stored in disk drive component 410 or some other non-volatile storage component for execution.

Although various components and steps have been described herein as being associated with user device 120, seller server 140, and payment service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure.

Having thus described embodiments of the disclosure, persons of ordinary skill in the art will recognize that changes may be made in form and detail without departing from the scope of the disclosure. Thus the disclosure is limited only by the claims.

What is claimed is:

1. A system comprising:
one or more processors; and
one or more memories in communication with the one or more processors and adapted to store a plurality of machine-readable instructions which when executed by the one or more processors are adapted to cause the system to:
receive information from a user about an intent to conduct a transaction;
determine a current location of the user;
determine one or more seller locations near the current location of the user; and
provide time delay information to the user for the one or more seller locations.

2. The system of claim 1, wherein the information from the user about an intent to conduct a transaction further comprises information about an item for purchase.

3. The system of claim 1, wherein the information from the user about an intent to conduct a transaction further comprises information about a type of seller.

4. The system of claim 1, wherein the plurality of machine-readable instructions are further adapted to cause the system to provide the user information about travel times for at least one of the seller locations.

5. The system of claim 4, wherein the information about travel times is based, at least in part, on a distance from the user to a seller location and a time period of travel.

6. The system of claim 1, wherein the plurality of machine-readable instructions are further adapted to cause the system to provide the user information about a seller with a fastest transaction time.

7. The system of claim 6, wherein the fastest transaction time is based on an estimated time to arrive at a seller location and an estimated wait time to check out at the seller location.

8. The system of claim 7, wherein the estimated wait time is based on historical data for the seller location from similar days and/or times.

9. The system of claim 7, wherein the estimated wait time is based on current data provided from the seller location.

10. The system of claim 9, wherein the current data is provided by one or more customers.

11. The system of claim 9, wherein the current data is provided by a seller.

12. A method comprising:
receiving, electronically by a processor, information from a user about an intent to conduct a transaction;
determining, electronically by the processor, a current location of the user;
determining, electronically by the processor, one or more seller locations near the current location of the user; and
providing, electronically by the processor, time delay information to the user for the one or more seller locations.

13. The method of claim 12, wherein the information from the user about an intent to conduct a transaction further comprises information about an item for purchase and/or information about a type of seller.

14. The method of claim 12, further comprising providing the user information about travel times for at least one of the seller locations.

15. The method of claim 15, wherein the information about travel times is based, at least in part, on a distance from the user to a seller location and a time period of travel.

16. The method of claim 12, further comprising providing the user information about a seller with a fastest transaction time.

17. The method of claim 17, wherein the fastest transaction time is based on an estimated time to arrive at a seller location and an estimated wait time to check out at the seller location.

18. The method of claim 18, wherein the estimated wait time is based on historical data for the seller location from similar days and/or times.

19. The method of claim 18, wherein the estimated wait time is based on current data provided from the seller location.

20. A non-transitory computer readable medium on which are stored computer readable instructions and, when executed by a processor, cause the processor to:
receive information from a user about an intent to conduct a transaction;
determine a current location of the user;
determine one or more seller locations near the current location of the user; and
provide time delay information to the user for the one or more seller locations.
